(19) United States
(12) Patent Application Publication
(10) Pub. No.: US 2019/0390978 A1
(43) Pub. Date: Dec. 26, 2019

(54) Using Inclination Angles of Marker Stripes on a Scale Band to Measure a Position

(71) Applicant: BOGEN Electronic GmbH, Berlin (DE)

(72) Inventors: Torsten Becker, Berlin (DE); Joern Hoyer, Grossbeeren (DE)

(21) Appl. No.: 16/560,968

(22) Filed: Sep. 4, 2019

Related U.S. Application Data
(63) Continuation-in-part of application No. 15/899,774, filed on Feb. 20, 2018, now abandoned.
Application No. 15/899,774 is a continuation of application No. 14/915,802, filed on Mar. 1, 2016, now abandoned.

(30) Foreign Application Priority Data
Sep. 4, 2013 (EP) 13183033.3

(51) Int. Cl. G01D 5/14; G01D 13/16

(52) U.S. Cl. CPC G01D 5/14; G01D 13/16

(57) ABSTRACT

A position measuring device includes a first object with a scale band and a second object. Marker stripes extend in a transverse direction from one side of the scale band to the opposite side. A longitudinal axis divides the scale band into first and second paths. First and second marker sensors on the second object pass over the first and second paths as the second object slides longitudinally along the scale band. Each transition between marker stripes is a straight line oriented at an inclination angle relative to the transverse direction. As the second object moves over each transition, the inclination angle of that transition is determined based on how the first and second marker sensors detect the transition over the first and second paths. The measuring device then determines that the second object is located at a particular transition based on the determined inclination angle associated with that transition.

### CROSS REFERENCE TO RELATED APPLICATION

This application is a continuation in part of, and claims priority under 35 U.S.C. § 120 from, U.S. patent application Ser. No. 15/899,774 entitled “Measuring Device and Method for Measuring the Position of Bodies,” filed on Feb. 20, 2018. Application Ser. No. 15/899,774, in turn, is a continuation of U.S. patent application Ser. No. 14/915,802 entitled “Measuring Device and Method for Measuring the Position of Bodies,” filed on Mar. 1, 2016. Application Ser. No. 14/915,802, in turn, is a National Stage of International PCT Patent Application No. PCT/EP2014/067356 filed Aug. 13, 2014, and claims the right of priority under 35 U.S.C. § 119 based on European Patent Application No. 13183033.3 filed Sep. 4, 2013. The entire contents of these applications are incorporated herein by reference in their entirety.

### TECHNICAL FIELD

The invention relates to a position measuring device and a method for measuring the positions of a first object relative to a second object neighboring the first object and being movable relative to the first object.

### BACKGROUND

It is known in machine tool manufacturing to use, for example, a magnetic linear scale for the determination of a position of a tool slide. The positions can be determined by a relative measurement or an absolute measurement. For the relative position determination, an indistinguishable bit pattern of alternating equally long north and south poles is measured. Since the single bits are not distinguishable, the positions are only relatively distinguishable, and the position is generally generated by counting the passed bits. In order to determine the absolute position, either the bit pattern is indicated by a second trace, or a distinguishable bit pattern is used. In the first case, the single bits are indicated by a further trace and are therefore made distinguishable. In the second case, for example, distinguishable bit patterns are used in which the single scale increments are differently wide, for example they enlarge from an absolute start point. However, it is obligatory required that the respective widths of the scale increments be present only once in order for the recognition of the absolute position to be unambiguous. However, the maximum measuring distance is thereby disadvantageously limited by the possibility of measuring the local length of the single widths and thereby assigning its absolute position.

It is an object of the invention to provide a measuring device and a method for measuring the position of a first object to a second object that neighbors the first object and is movable relative to the first object, wherein the distance range, in which its position can be, is large.

The object is solved with the features of the independent patent claims. Preferred embodiments thereto are given in the further patent claims.

### SUMMARY

A measuring device for measuring the position of a first object relative to a second object includes a scale band that can be attached to the first object and that includes a marker. The measuring device includes two marker detection sensors that are attached to the second object. The marker is formed by a pattern formed form marker stripes, in which transitions between marker stripes from a first position of the scale band to a second position of the scale band are oriented at predetermined inclines to the transverse direction of the scale band at such inclination angles that each of the inclination angles has a value that differs from the values of the other inclination angles. The scale band is divided into a first path and a second path. One of the marker detection sensors is located neighboring the first path, and the other of the marker detection sensors is located neighboring the second path. In addition, the marker detection sensors are arranged seen in the transverse direction of the scale band next to each other between the first position and the second position, so that the position of the first object to the second object can be determined within the first and the second position by detecting the inclination angles. The position of the objects is determined based on the detected inclination angles.

A position measuring device includes a first object with a scale band and a second object with first and second marker detection sensors. The scale band is formed by a plurality of marker stripes and is disposed along the first object in a longitudinal direction. Each of the marker stripes extends in a generally transverse direction from one side of the scale band to an opposite side of the scale band. The scale band is divided in the transverse direction by a longitudinal center axis into a first path and a second path. First and second marker detection sensors are attached to the second object such that the first marker detection sensor passes over the first path and the second marker detection sensor passes over the second path as the second object slides over the scale band in the longitudinal direction by a longitudinal distance from a first position to a second position.

Each transition between adjacent marker stripes is a straight line that is oriented at an inclination angle relative to the transverse direction. In one embodiment, the inclination angle ranges from zero to sixty degrees. Except for a first inclination angle of a first transition at the first position, each of the inclination angles of the transitions between adjacent marker stripes over the longitudinal distance has a magnitude that differs from that of every other transition within the longitudinal distance. In one aspect, the inclination angles of the transitions between adjacent marker stripes over the longitudinal distance from the first position to the second position at first increase in magnitude from the first inclination angle of zero degrees at the first position and then decrease in magnitude to a second inclination angle of zero degrees at the second position.

As the second object slides over the scale band, the measuring device determines the inclination angle of each transition by comparing when the first marker detection sensor along the first path passes over the transition relative to when the second marker detection sensor along the second path passes over the same transition. The measuring device determines where the second object is located along the scale band within the longitudinal distance based on the inclination angle determined for the transition over which the first marker detection sensor and the second marker detection sensor are located. In another embodiment, as the second object moves over each transition the measuring device determines the inclination angle of that transition based on how the first marker detection sensor detects the transition along the first path and how the second marker detection sensor detects the transition along the second path. The measuring device then determines that the second object is located at that transition based on the determined inclination angle associated with that transition.

Each marker stripe is shaped as a trapezoid, with the longitudinal upper and lower sides parallel to one another. The generally transverse sides extend in straight lines from the upper side of the scale band to the lower side of the scale band. In one embodiment, the marker stripes are formed by coloring portions of the scale band, in which case the marker detection sensors are optical sensors. For example, the scale band can form a pattern of alternating bright and dark marker stripes. In another embodiment, the marker stripes are formed by oppositely magnetizing adjacent marker stripes, in which case the marker detection sensors are magnetic sensors. Each marker stripe can be a permanent magnet. For example, the marker stripes can be formed by magnetizing portions of the scale band, and the marker detection sensors can include coils in which currents are induced as the coils pass over the transitions between adjacent marker stripes.

Other embodiments and advantages are described in the detailed description below. This summary does not purport to define the invention. The invention is defined by the claims.

### BRIEF DESCRIPTION OF THE DRAWING

The accompanying drawings, where like numerals indicate like components, illustrate embodiments of the invention.

FIG. 1 shows a top view of the preferred embodiment of the measuring device according to the invention.

FIG. 2 is a more detailed view of FIG. 1.

### DETAILED DESCRIPTION

Reference will now be made in detail to some embodiments of the invention, examples of which are illustrated in the accompanying drawings.

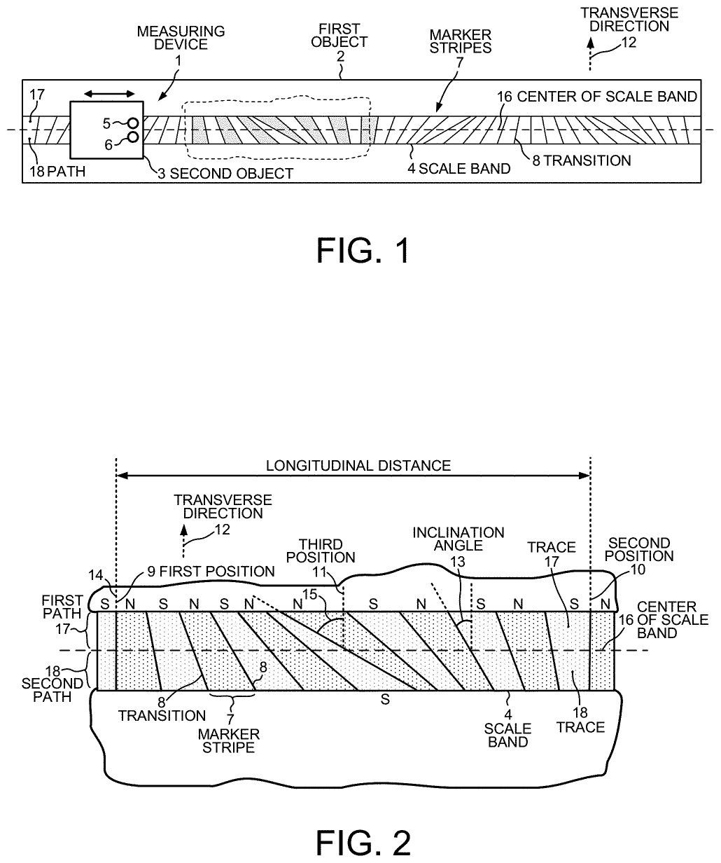

FIG. 1 shows a measuring device 1 that uses inclination angles 13 of marker stripes 7 on a scale band 4 to measure the position of a second object 3 on a first object 2. The measuring device 1 according to the invention for measuring the position of the first object 2 relative to the second object 3 that neighbors the first object 2 and is movable relative to the first object 2 includes the scale band 4 with marker stripes 7 that can be attached to the first object 2. The measuring device 1 includes two marker detection sensors 5-6 that are attached to the second object 3. A marker on the scale band 4 is formed by a pattern of marker stripes 7 that transitions from marker stripe to marker stripe between a first position of the scale band 4 and a second position that is located in the longitudinal direction of the scale band 4 at a distance to the first position. The marker stripes 7 are respectively arranged at predetermined inclines to the transverse direction 12 in such a respective inclination angle 13 that each of the inclination angles has a value that differs from the values of the other inclination angles. The scale band 4 is divided in the transverse direction 12 into two paths 17-18. One of the marker detection sensors is arranged adjacent to the first path and the other of the marker detection sensors is arranged adjacent to the second path. In addition, the marker detection sensors are arranged seen in the transverse direction 12 of the scale band 4 next to each other between the first position and the second position, so that the position of the first object 2 to the second object 3 can be determined within the first and the second position by detecting the inclination angles of the marker stripes 7.

Since the both paths are located next to each other on the scale band 4, the marker detection sensors are advantageously also arranged next to each other in the transverse direction 12 of the scale band 4 allowing the complete range between the first position and the second position to be captured by the marker detection sensors. Therefore, the position of the first object 2 to the second object 3 can be on an arbitrary location between the first position and the second position. For example, a displacement of the marker detection sensors in the longitudinal direction of the scale band 4 does not need to be provided. Such a displacement would disadvantageously lead to a shortening of the measuring distance between the first position and the second position.

The marker stripes 7 extend from the first path through to the second path without making any step at the boundary or transition between the two paths. Thus, the boundaries between adjacent marker stripes 7 are straight lines. The straight line transitions extend from one side of the scale band 4 to the opposite side in the transverse direction. The location of the leading edge of each marker stripe 7 can be unambiguously determined based on the inclination angle 13 of the leading edge of the marker stripe. An exact determination of the position of both objects with respect to each other within the measuring distance defined by the first position and the second position is therefore advantageously achieved by the measurement device according to the invention.

The scale band 4 is preferably divided into a first path on one side of the center axis of the band and into a second path on the other side of the center axis. The marker stripes 7 are preferably formed in the shape of trapezoids. Each marker stripe is a unitary object as opposed to separate parts in the first path 17 and in the second path 18. Thus, the magnetic polarity along the entire boundary between marker stripes can be the same. It is preferred for the pattern that it is alternating or it is generated by an arbitrary change of properties. Thus, alternating magnetic fields can be present on opposite sides of transitions between adjacent marker stripes 7, for example alternating between north, south, north, south, etc. In one embodiment, the marker stripes 7 are formed by colorings of the surface of the scale band 4, and the marker detection sensors are optical sensors or cameras. For example, the marker stripes 7 can form a bright-dark striped pattern, for example a white-black striped pattern. In another example, the markers are formed by white-black-white patterns. In another embodiment, the marker stripes 7 are formed by permanent magnetic poles of the scale band 4, and the marker detection sensors 5-6 are magnetic sensors. For example, the magnetic sensors can be magnetoresistive sensors or Hall-sensors.

The detected inclination angles are preferably processed during the determination of the position of the first object 2 to the second object 3 within the first and the second position such that a phase displacement or the polarity of the signals of the marker detection sensors are determined.

It is preferred that the marker stripe transitions on the first and the second position respectively have a minimum angle as their inclination angle 13 as well as one of the marker stripe transitions is arranged between both positions on a third position of the scale band 4. The marker stripe transitions are arranged inclined at a maximum angle to the transverse direction 12 of the scale band 4. The inclination angles of the marker stripe transitions that are disposed between the first position and the third position and that are arranged between the second position and the third position increase in direction to the third position monotonically from the minimum angle to the maximum angle. It is hereby preferred that the marker stripes 7 seen in the longitudinal direction of the scale band 4 have respectively the same width in the center of the scale band 4. It is further preferred that the minimum angle is 0°. The maximum angle is preferably 90°, in particular 60°.

The number of transitions or boundaries 8 of the marker stripes 7 from one of the marker stripes to the neighboring marker stripe between the first position and the third position and the number of the marker stripe transitions from one of the marker stripes to the neighboring marker stripe between the second position and the third position are preferably equally high. Furthermore, the inclination angles 13 of the marker stripes 7 that are arranged between the first position and the third position and that are arranged between the second position and the third position preferably increase strictly monotonically in direction to the third position from the minimum angle to the maximum angle.

If the scale band 4 is preferably provided with the magnetic marker stripes 7, during the manufacturing of the scale band 4 a writing tool is moved with constant translational velocity along the scale band 4 during the magnetization and is thereby pivoted, for example, around the center of the scale band 4, such that the marker stripes 7 lying next to each other are formed inclined to each other and are formed in the shape of trapezoids. The polarity of the writing tool is thereby reversed in equal time intervals, so that the widths of the marker stripes 7 to the edges of the scale band 4 are geometrically expanded or compressed. If, for example, the scale band 4 is 10 mm wide, a maximum angle up to 60° can be achieved with a writing tool of 20 mm width. During the manufacturing of the scale band 4, the writing tool is therefore to be pivoted starting from the minimum inclination angle of 0° to the maximum inclination angle of 60° and then back to the minimum angle of 0°. The manufacturing of both paths can therefore advantageously be achieved in one single working step. Furthermore, it is possible for a full modulation wavelength of the marker stripes 7 to be between the first position and the second position because two amounts of information in the form of the locally present inclination angles of the marker stripe transitions are simultaneously present by the both marker detection sensors.

The method according to the invention for measuring the position of the first object 2 with respect to the second object 3 includes the steps: providing the measuring device according to the invention; capturing the amplitude of the signals of the marker detection sensors; determining the position of the objects to each other within the first position and the second position by means of the inclination angles detected by the marker detection sensors.

FIG. 1 shows a measuring device 1 that measures the position of a first object 2 relative to a second object 3. The first object 2 is, for example, formed as a rail, whereas the second object 3 is, for example, formed as a slider. The second object 3 can be moved relative to the first object 2 such that the absolute position of the second object 3 on the first object 2 can be determined using the measuring device 1.

The measuring device 1 includes a scale band 4 that is applied onto the first object 2. It is conceivable that the scale band 4 lies as a separate band on the first object 2. The scale band 4 could also be directly formed on the surface of the first object 2. It is conceivable that the first object 2 is formed as a cylinder, and the scale band 4 is cyclically closed. In addition, the second object 3 includes a first marker detection sensor 5 and a second marker detection sensor 6. The second object 3 is moved relative to the first object 2 such that the marker detection sensors 5-6 move along the scale band 4. The marker detection sensors 5-6 are magnetoresistive sensors or Hall-sensors.

The scale band 4 is made out of a ferromagnetic material with high energy density or a magnetically hard material. A magnetizing head that is aligned transverse to the scale band 4 was moved over the scale band 4 during the magnetizing of the scale band 4 such that the magnetizing head was alternatingly pivoted around the transverse direction 12 of the scale band 4. The scale band 4 was thereby provided with a multitude of marker stripes 7 in which each marker stripe 7 is either formed as a north pole or a south pole. The marker stripes 7 are alternatingly magnetized with north and south poles, so that boundaries or transitions 8 in the shape of pole transitions are formed from each marker stripe to the adjacent marker stripe. The scale band 4 can be formed by a direct magnetization of the surface of the first object 2 if the first object 2 includes a material that can be magnetized.

FIG. 2 shows first, second and third positions on scale band 4. The first position 9 is defined on the scale band 4, and the second position 10 is defined at a longitudinal distance away from the first position. The third position 11 is located in the center between the first position 9 and the second position 10. The transverse direction 12 is defined in the plane in which the scale band 4 lies, normal to the scale band 4. Each of the transitions 8 has an inclination angle 13 to the transverse direction 12. One of the transitions 8 is located at the first position 9 and has an inclination angle 13 of 0°. Another of the transitions 8 is located at the second position 10 and also has an inclination angle of 0°. The transitions 8 that are arranged between the first position 9 and the second position 10 have inclination angles that are larger than the inclination angles of the transitions 8 in the first position 9 and the second position 10, so that the transitions 8 in the first position 9 and the second position 10 have the minimum angle 14 of 0°. A plurality of the transitions 8 are arranged between the first position 9 and the second position 10 such that the inclination angle 13 of the transitions 8 increases from the first position 9 to the third position 11 and then decreases again from the third position 11 to the second position 10. The transition 8 at which the inclination angle 13 is largest is located at the third position 11, so that this inclination angle is the maximum angle 15. In this embodiment, the maximum angle 15 is 60°.

The longitudinal distances between the transitions 8 are respectively equally large in the center 16 of the scale band 4. FIGS. 1-2 show a first path 17 located above the center 16 of the scale band and a second path 18 located below the center. The upper halves of the transitions 8 are therefore disposed on the first path 17, whereas the lower halves of the transitions 8 are disposed on the second path 18. However, the upper half and lower half of each marker stripe 7 are integrally formed as one stripe such that the scale band 4 is a single track. The marker detection sensors 5-6 are arranged adjacent to each other in the transverse direction 12 on the second object 3. The first marker detection sensor 5 is arranged over the first path 17 and perpendicular to the plane of FIG. 1 above the scale band 4. The second marker detection sensor 6 is arranged in an analogous manner above to second path 18 and perpendicular to the plane of FIG. 1 above the scale band 4. During a relative movement of the second object 3 to the first object 2, which is indicated by an arrow in FIG. 1, the marker detection sensors 5-6 are moved above the scale band 4 such that the first marker detection sensor 5 follows the first path 17, and the second marker detection sensor 6 follows the second path 18.

If the marker detection sensors 5-6 are arranged between the first position 9 and the second position 10, the marker detection sensors 5-6 capture the inclination angle 13 of the corresponding transitions 8 that are disposed immediately adjacent to the respective marker detection sensors 5-6. The absolute position of the second object 3 can be unambiguously determined by means of the given distribution of the inclination angles 13 between the first position 9 and the second position 10 and based on the inclination angles 13 of the immediately adjacent transitions 8 detected by the marker detection sensors, respectively, dependent on the gradients of the inclination angles detected by the marker detection sensors.

Because the marker detection sensors 5-6 are arranged in a row along the transverse direction 12 and next to each other in the longitudinal direction of the scale band 4, both marker detection sensors 5-6 can be moved to the first position 9 and to the second position 10 such that all transitions 8 situated between the first position 9 and the second position 10 are captured by the marker detection sensors 5-6 and therefore each position of the second object 3 between the first position 9 and the second position 10 can be determined. For example, protrusions of the scale band 4 above the first position 9, respectively the second position 10 do need to be provided.

In one embodiment, the inclination angle 13 of the leading edge of the approaching marker stripe 7, as the second object 3 moves from the first position 9 to the second position 10, is determined based on the time at which one of the detection sensors 5-6 senses the transition 8 to the approaching marker stripe 7 compared to the time at which the other of the detection sensors 5-6 senses the transition 8 to the same approaching marker stripe 7. The detection of the transition 8 to the approaching marker stripe 7 by both sensors 5-6 is performed while the second object 3 is moving at a constant speed at least from the time the first detection sensor senses the transition 8 until the time that the other detection sensor senses the same transition 8.

Except where the inclination angle 13 is the minimum angle 14 of 0°, the first marker detection sensor 5 senses the boundary of the next marker stripe 7 along the first path 17 either before or after the second marker detection sensor 6 senses the boundary of the next marker stripe 7 along the second path 18. The difference in the time at which the boundary or transition 8 is detected along the first path 17 compared to the second path 18 is used to calculate the inclination angle 13. The greater the difference in time between when the transition 8 is detected by the two sensors 5-6, the greater the angle of inclination 13. In the localized area on the scale band 4 shown in FIG. 2, first sensor 5 detects the transition 8 either before or at the same time as second sensor 6 detects the transition 8. For example, for the maximum angle 15 of inclination, the second market detection sensor 6 detects the transition 8 from a south pole stripe to a north pole stripe the greatest amount of time after the first marker detection sensor 5 senses the same transition 8 from south pole to north pole. In one embodiment, each marker detection sensor senses a transition when a current is induced as a coil of the sensor passes over the boundary of the changing magnetic field from south to north or from north to south. As each sensor passes over the transition 8, the amplitude of the sensor signal received from the sensor increases.

In the localized area on the scale band 4 shown in FIG. 2, the inclination angle 13 of the leading edge of each marker stripe 7 has a unique value. The location of the second object 3 over the first object 2 is determined by measuring and calculating the inclination angle 13 of the transition over which the second object 3 is positioned, and then comparing the measured inclination angle to a matching known inclination angle of a particular marker stripe 7. The position of the last sensor on the second object 3 to detect the transition 8 is determined to be over the transition 8 of the approaching marker stripe 7 whose known inclination angle is the same as the inclination angle detected by the two sensors 5-6 as calculated by the measuring device 1. In another embodiment, the position of the second object 3 over the first object 2 is determined based on the difference between the detected inclination angle and the previously detected inclination angle. In this case, each difference in inclination angles 13 between adjacent marker stripes 7 within a localized area is unique.

### REFERENCE NUMERALS

1 measuring device

2 first object

3 second object

4 scale band

5 first marker detection sensor

6 second marker detection sensor

7 marker stripes

8 transitions

9 first position

10 second position

11 third position

12 transverse direction

13 inclination angle

14 minimum angle

15 maximum angle

16 center of the scale band

17 first path

18 second path

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-14. (canceled)

15. A measuring device, comprising:
a first object;
a scale band disposed along the first object in a longitudinal direction, wherein the scale band is formed by a plurality of marker stripes, wherein each of the marker stripes extends in a generally transverse direction from one side of the scale band to an opposite side of the scale band, and wherein the scale band is divided in the transverse direction by a longitudinal center axis into a first path and a second path; and
a second object to which a first marker detection sensor and a second marker detection sensor are attached, wherein the first marker detection sensor passes over the first path and the second marker detection sensor passes over the second path as the second object slides over the scale band in the longitudinal direction by a longitudinal distance from a first position to a second position, wherein each transition between adjacent marker stripes is a straight line that is oriented at an inclination angle relative to the transverse direction that ranges from zero to sixty degrees, wherein except for a first inclination angle of a first transition at the first position each of the inclination angles of the transitions between adjacent marker stripes over the longitudinal distance has a magnitude that differs from that of every other transition within the longitudinal distance, wherein as the second object slides over the scale band the measuring device determines the inclination angle of each transition by comparing when the first marker detection sensor along the first path passes over the transition relative to when the second marker detection sensor along the second path passes over the transition, and wherein the measuring device determines where the second object is located along the scale band within the longitudinal distance based on the inclination angle determined for the transition over which the first marker detection sensor and the second marker detection sensor are located.

16. The measuring device of claim 15, wherein each marker stripe is shaped as a trapezoid.

17. The measuring device of claim 15, wherein the marker stripes are formed by coloring portions of the scale band, and wherein the marker detection sensors are optical sensors.

18. The measuring device of claim 15, wherein the scale band forms a pattern of alternating bright and dark marker stripes.

19. The measuring device of claim 15, wherein the marker stripes are formed by oppositely magnetizing adjacent marker stripes, and wherein the marker detection sensors are magnetic sensors.

20. The measuring device of claim 15, wherein the marker stripes are formed by magnetizing portions of the scale band, and wherein the marker detection sensors include coils in which currents are induced as the coils pass over the transitions between adjacent marker stripes.

21. The measuring device of claim 15, wherein each marker stripe is a permanent magnet.

22. The measuring device of claim 15, wherein the marker detection sensors are taken from the group consisting of: magnetoresistive sensors and Hall sensors.

23. The measuring device of claim 15, wherein the inclination angles of the transitions between adjacent marker stripes over the longitudinal distance from the first position to the second position at first increase in magnitude from the first inclination angle of zero degrees at the first position and then decrease in magnitude to a second inclination angle of zero degrees at the second position.

24. The measuring device of claim 23, wherein an equal number of transitions between adjacent marker stripes from the first position to the second position have an increasing inclination angle as have a decreasing inclination angle.

25. The measuring device of claim 15, wherein all of the marker stripes have an identical width at their middles where the center axis of the scale band intersects the marker stripes.

26. A measuring device, comprising:
a first object;
a scale band disposed along the first object in a longitudinal direction, wherein the scale band includes a plurality of marker stripes and is divided in a transverse direction into a first path and a second path, and wherein each of the marker stripes extends from one side of the scale band to an opposite side of the scale band; and
a second object to which a first marker detection sensor and a second marker detection sensor are attached, wherein the first marker detection sensor passes over the first path and the second marker detection sensor passes over the second path as the second object slides over the scale band in the longitudinal direction from a first position to a second position, wherein each transition between adjacent marker stripes is a straight line that is oriented at an inclination angle relative to the transverse direction, wherein except for a first inclination angle of a first transition at the first position each of the inclination angles of the transitions between adjacent marker stripes has a magnitude that differs from that of every other transition from the first position to the second position, wherein as the second object moves over the scale band the measuring device determines the inclination angle of each transition by comparing when the first marker detection sensor along the first path passes over the transition relative to when the second marker detection sensor along the second path passes over the transition, and wherein the measuring device determines where the second object is located along the scale band based on the inclination angle determined for the transition over which one of the first marker detection sensor or the second marker detection sensor is located.

27. The measuring device of claim 26, wherein the measuring device determines where the second object is located along the scale band based on the position of the last of the first marker detection sensor or the second marker detection sensor that detects the transition for which the inclination angle was determined.

28. The measuring device of claim 26, wherein each marker stripe is shaped as a trapezoid.

29. The measuring device of claim 26, wherein adjacent marker stripes have differing colors, and wherein the marker detection sensors are optical sensors.

30. The measuring device of claim 26, wherein adjacent marker stripes are oppositely magnetized, and wherein the marker detection sensors include coils in which currents are induced as the coils pass over the transitions between adjacent marker stripes.

31. The measuring device of claim 26, wherein each marker stripe is a permanent magnet.

32. The measuring device of claim 26, wherein the inclination angles of the transitions between adjacent marker stripes moving from the first position to the second position at first increase in magnitude from the first inclination angle of zero degrees at the first position and then decrease in magnitude to a second inclination angle of zero degrees at the second position.

33. The measuring device of claim 26, wherein a longitudinal center axis divides the scale band into the first path and the second path, and wherein all of the marker stripes have an identical width at their middles where the longitudinal center axis intersects the marker stripes.

34. A position measuring device, comprising:
a first object;
a scale band disposed along the first object in a longitudinal direction, wherein the scale band includes a plurality of marker stripes and is divided in a transverse direction into a first path and a second path, and wherein each of the marker stripes extends from one side of the scale band to an opposite side of the scale band; and
a second object to which a first marker detection sensor and a second marker detection sensor are attached, wherein the first marker detection sensor passes over the first path and the second marker detection sensor passes over the second path as the second object moves over the scale band in the longitudinal direction from a first position to a second position, wherein each transition between adjacent marker stripes is a straight line that is oriented at an inclination angle relative to the transverse direction, wherein except for a first inclination angle of a first transition at the first position each of the inclination angles of the transitions between adjacent marker stripes has a magnitude that differs from that of every other transition from the first position to the second position, wherein as the second object moves over each transition the measuring device determines the inclination angle of that transition based on how the first marker detection sensor detects the transition along the first path and how the second marker detection sensor detects the transition along the second path, and wherein the measuring device determines that the second object is located at that transition based on the determined inclination angle associated with that transition.
